(19) United States
(12) Patent Application Publication
(10) Pub. No.: US 2022/0269890 A1
(43) Pub. Date: Aug. 25, 2022

(54) METHOD AND SYSTEM FOR VISUAL ANALYSIS AND ASSESSMENT OF CUSTOMER INTERACTION AT A SCENE

(71) Applicant: BriefCam Ltd., Modiin (IL)

(72) Inventors: Shmuel PELEG, Mevaseret Zion (IL); Igal Dvir, Zichron Yaakov (IL); Mark Storek, Myakka City, FL (US); Yevsey Liokumovich, Waltham, MA (US); Elhanan Hayim Elboher, Modiin-Maccabim-Reut (IL); Ariel Naim, Beit Zait (IL); Gili Rom, New York, NY (US)

(73) Assignee: BriefCam Ltd., Modiin (IL)

(21) Appl. No.: 17/524,751

(22) Filed: Nov. 12, 2021

Related U.S. Application Data
(60) Provisional application No. 63/151,821, filed on Feb. 22, 2021.
(60) Provisional application No. 63/239,943, filed on Sep. 2, 2021.

(51) Int. Cl. G06K 9/00; H04N 5/247; G06K 9/62; G06Q 10/06

(52) U.S. Cl. CPC G06K 9/00718; G06K 9/00744; G06K 9/00771; H04N 5/247; G06K 9/00335; G06K 9/628; G06K 9/00362; G06Q 10/06398; G06K 2009/00738

(57) ABSTRACT

A system and a method for visual analysis of customer interaction at a scene are provided herein. The method may include: receiving at least one video sequence comprising a sequence of frames, captured by cameras covering the scene which includes at least one staff person and at least one customer; detecting, using a computer processor, persons in the at least one video sequence; classifying, using the computer processor, the persons to at least one customer; calculating a signature for the at least one person, enabling a recognition of the at least person appearing in other frames of the video sequences; and carrying out a visual analysis, using the computer processor and based on the at least one video sequence of at least one customer interaction which is visible at the scene, to yield an indication of the interaction between the staff person and the at least one customer.

### CROSS REFERENCE TO RELATED APPLICATIONS

This application is a non-provisional Patent Application claiming the benefit of U.S. Provisional Patent Application No. 63/239,943, filed Sep. 2, 2021, and U.S. Provisional Patent Application No. 63/151,821, filed Feb. 22, 2021, both of which are incorporated herein by reference in their entireties.

### FIELD OF THE INVENTION

The present invention relates generally to the field of video analytics, and more particularly to assessing customer interaction at a scene based on visual analysis.

### BACKGROUND OF THE INVENTION

Customers interaction with the environment of a business or with people that should serve them, plays an important role in evaluating user experience. Some examples for customer interaction may include salesmen in stores helping customers to define and find their needs, casino stuff such as dealers or drink waiters interacting with customers, bellboys in hotels serving visitors, waiters in restaurants taking orders and serving food to customers, and medical staff serving patients, in hospitals. A customer interaction with the business environment may include an interaction of the goods, inspection thereof and time spent in proximity to the goods presented.

Another indication for customer and staff person interaction is classifying of the actions and the interaction or lack thereof. For example, determining that the customer or the staff person in speaking/watching their smart phones. A good use case to detect is a customer that waits for help while a staff person ignores him because usage of the smartphone.

Currently there are some software tools known in the art that enable to monitor interaction in call/contact centers, measuring aspects like the length of conversations, satisfaction of customers, repeating calls, and the like. The monitoring is carried out in to measure, manage and improve their customers' engagement level. Some monitoring software are directed at interaction in the physical world, such as interactions in stores, but is limited to in the sense that it assumes that people carry some devices that indicate their location or monitor the location of people (without distinguishing customers from service providers) within a specific camera field of view.

### SUMMARY OF THE INVENTION

The present invention, in embodiments thereof, provide a method for visual analysis of customer interaction at a scene. The method may include the following steps: receiving at least one video sequence comprising a sequence of frames, captured by one or more cameras covering at least a portion of the scene; detecting, using at least one computer processor, persons in the at least one video sequence; classifying, using the at least one computer processor, the persons to at least one customer; calculating a signature for the at least one person, enabling a recognition of the at least person appearing in other frames of the one or more video sequences; obtaining customer data relating to the at least one customer, the customer data comprising at least one of: data of the at least one customer extracted from data sources other than the at least one video sequence, or data of the at least one customer extracted from the at least one video sequence; and carrying out a visual analysis, using the at least one computer processor and based on the at least one video sequence and the customer data, of at least one visible interaction between at least one staff person present at the scene and the at least one customer, to yield an indication of the interaction between the staff person and the at least one customer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating an architecture of a system in accordance with some embodiments of the present invention;

FIG. 2 is a high-level flowchart illustrating a method in accordance with some embodiments of the present invention;

FIG. 3A is another high-level flowchart illustrating a method in accordance with some embodiments of the present invention; and

FIG. 3B is yet another high-level flowchart illustrating a method in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Prior to setting forth the detailed description of the invention, it may be helpful to set forth definitions of certain terms that will be used hereinafter.

The term “signature” as used herein is defined as a relatively short sequence of numbers computed from a much larger set of numbers, such as an image, a video, or a signal. Signatures are computed with the goal that similar objects will yield similar signatures. Signatures can be computed by a pre-trained neural network, and can be used, for example, to determine if two different pictures of a face are of the same or different persons. In the face recognition case, for example, the input image can have about one million pixels, and the signature can be a vector of 512 or 1024 numbers.

The term “skeleton” as used herein is defined as a simplified model of a human body, represented by straight lines connected by joints to represent major body parts. The skeleton representation is much more simplified that the biological skeleton of a human, and its parts do not necessarily correspond to any real joints or other human body parts.

In the following description, various aspects of the present invention will be described. For purposes of explanation, specific configurations and details are set forth to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

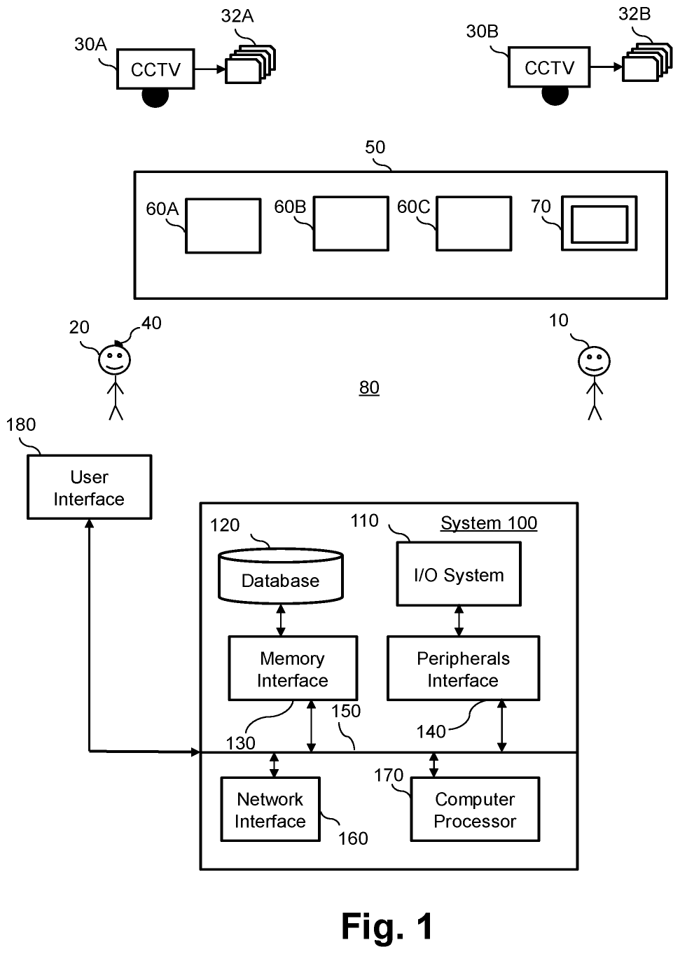

FIG. 1 is a block diagram showing system 100 and closed-circuit television (CCTV) cameras 30A and 30B located in a scene 80 and are configured to capture portions of scene 80 and generate video sequences 32A and 32B respectively. Scene 80 may include a sales floor of a business where customers such as customer 10 are visiting to look at goods such as goods 60A-60C or receive other services.

Scene 80 may also include at least one person who is serving on the customers, such as staff person 20. Staff person 20 may be equipped with a body mounted camera 40 configured to capture portions of scene 80 and generate a video sequence (not shown). A user interface 180 such as a point-of-sale terminal or any other computer terminal may also be presented at the scene allowing staff person 20 to interact with system 100.

System 100 and cameras 30A, 30B, and 40 are in communication directly or indirectly via a bus 150 (or other communication mechanism) that interconnects subsystems and components for transferring information within system 100 and/or cameras 30A, 30B, and 40 and user interface 180. For example, bus 150 may interconnect a computer processor 170, a memory interface 130, a network interface 160, a peripherals interface 140 connected to I/O system 110.

According to some embodiments of the present invention, system 100 based on video cameras 30A, 30B, and 40 may be configured to monitor areas where customers such as customer and servers interact, such as stores, restaurants, or hotels. Video cameras can be existing security cameras, or additional cameras installed for the purpose of interaction analysis. A system will analyze the captured video, will detect people, classify each person as a customer of a staff person, and will provide analysis of such interactions. For example (i) Statistics about the time it takes each salesperson to approach a customer; (ii) Statistics about how many customers leave the store with (or without) a purchase after their interactions with each salesperson. (iii) What are the statistics of the length of customer interactions, and the relation of the length of interaction to a successful sale; and (iv) Statistics about the number of interactions between salesmen and different customers during his shift. (v) Each such statistics can include sample video clips showing some of the considered interactions.

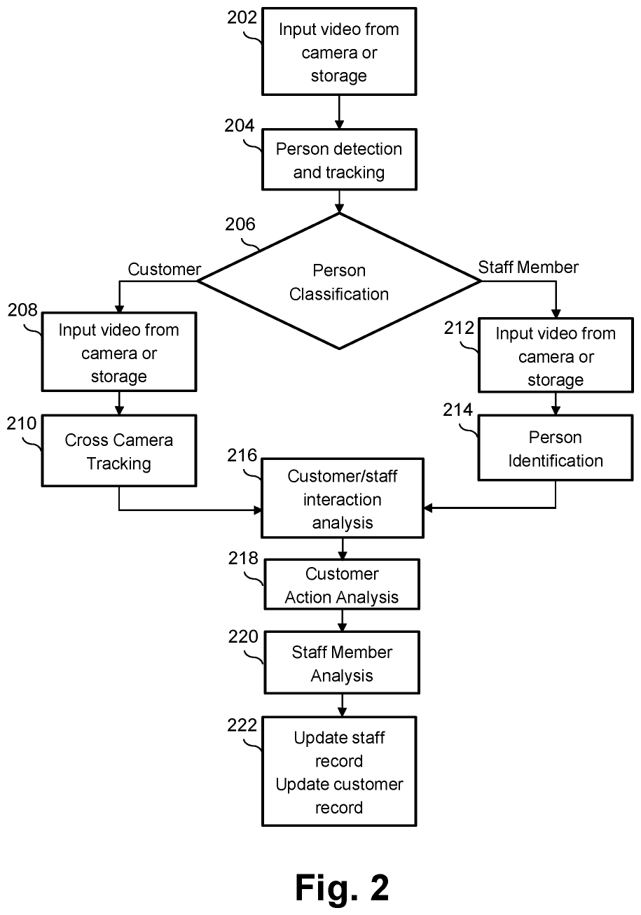

FIG. 2 is a high-level flowchart illustrating a method in accordance with some embodiments of the present invention. Method 200 in accordance with some embodiments of the present invention may address the use case where both customers and staff persons are moving freely on the shop floor, and to analyze interactions, the following steps may be carried out upon the recorded video 202: detecting and tracking people in the video 204, determining who is a customer and who is a staff person 206, based on input video 208 and 212, carrying out visual analysis, including person identification 214; specifying the periods of interactions between a customer and a staff person 216; tracking customers along the facility, possibly across multiple cameras 210, while visiting different locations in the scene; and classifying the outcome of this interaction 218, 220. This may also be relevant to detect staff member actions (for example busy with his phone). Staff and customer records can be also updated 222.

According to some embodiments of the present invention, the steps of detecting and tracking people in the video, and the determining who is a customer and who is a staff person may be best accomplished by methods for people detection and tracking in video, followed by determining who are the staff persons among the detected people. There are many possibilities to perform this task, that can be taken separately or together. Example of such possibilities include but are not limited to building a library based on face pictures of the staff persons and recognize the staff persons by face recognition.

Alternatively, according to some embodiments of the present invention, in case the staff persons have a special dress, e.g., have a unique uniform or a unique dress element, this uniform can serve to identify them. Such identification can be done by the following process: In the setup of the system—identifying people as such (e.g., determining where are the people in the frames). Further during the setup of the system—allowing a user to select from the identified people, the ones that are wearing the unique clothing articles. Additionally, during the setup of the system—training a neural network based on positive examples (selected people wearing special clothes) vs. negative examples (the rest of the people) to classify people that are wearing special clothes. Then, during run-time—the trained neural network can distinguish for every detected person, whether he or she is a staff person (wearing special clothes) or a customer.

According to some embodiments of the present invention, the identification and tracking of human subjects in the video sequences, re-identifying them based on a signature or using neural network to do so can be carried out by methods disclosed in the following publications:
Wei Li, Rui Zhao, Tong Xiao, Xiaogang Wang; DeepReID: Deep Filter Pairing Neural Network for Person Re-Identification; Proc. of the IEEE Conf. on Computer Vision and Pattern Recognition (CVPR), 2014, pp. 152-159;
S. M. Marvasti-Zadeh, L. Cheng, H. Ghanei-Yakhdan, and S. Kasaei, “Deep Learning for Visual Tracking: A Comprehensive Survey,” in IEEE Trans. on Intelligent Transportation Systems, 2020;
Y. Zhou, “Deep Learning Based People Detection, Tracking and Re-identification in Intelligent Video Surveillance System,” 2020 Int. Conf on Computing and Data Science (CDS), 2020;
M. Fabbri, S. Calderara and R Cucchiara, “Generative adversarial models for people attribute recognition in surveillance,” 2017 14th IEEE Int. Conf. on Advanced Video and Signal Based Surveillance (AVSS), 2017; and
Y. Zhou, D. Liu and T. Huang, “Survey of Face Detection on Low-Quality Images” 2018 13th IEEE Inte. Conf on Automatic Face & Gesture Recognition (FG 2018), 2018.

Alternatively, according to some embodiments of the present invention, staff persons may be recognized by a visible badge, name tag, or any other accessory. Alternatively, they may be provided with a unique accessory to help their identification.

Alternatively, according to some embodiments of the present invention, staff persons can even be recognized without any previous designation, by measuring the continuous length of time they spend on the shop floor, mostly without purchasing anything. Staff persons will spend much more time in the location than any customer.

According to some embodiments of the present invention and by way of a default, any person that is not identified as a staff person will be considered a customer.

According to some embodiments of the present invention, the step of specifying the periods of interactions between a customer and a staff person can also be addressed in multiple approaches. The simplest approach is to measure from the video the locations of all people in the scene and use the proximity between customer and server to indicate interaction. For example, some duration at a proximity may be regarded as interaction. This can further be enhanced using video gesture and posture analysis to find gestures common in interactions. For example, two people are likely to interact if they look at each other. Posture is the way someone is sitting or standing. Oppositely, a gesture is the body movement of a person. Analyzing postures and gestures may be done by various methods known in the art some including the steps of segmentation, classification, and aggregation.

Another way to analyze two people's engagement is through analyzing their pose that can be derived from the video. In addition to verifying that they are looking at each other, the way they move their hands can indicate that the staff person is showing something to the customer or giving him something.

If any of the relevant people is actively aware of the video cameras, interaction could also be detected according to predetermined hand gestures, e.g., waving to the camera to signal interaction. There are multiple choices to predetermine the usage of such a method. One option to use it to detect interaction is if all relevant people perform the hand gesture. Another option is to use a hand gesture as a signal to the camera, and detect interactions only around this signal, according to the methods mentioned above.

According to some embodiments of the present invention, the steps of tracking customers along the facility, possibly across multiple cameras, while visiting different locations in the scene; and classifying the outcome of this interaction can be determined by watching in the video the customer's actions following the interaction. For example—does the customer leave the place empty handed? Does the customer pick up a product and go to the cash register or to the fitting rooms? Interface with the cash register system can provide an accurate description of the purchased product and its value.

According to some embodiments of the present invention, system 100 can be implemented using single camera covering the sales floor, or by a system of multiple cameras. In each case the ability to track the customers in the field of view of each camera, and between cameras, is needed.

According to some embodiments of the present invention, assessing the visible interaction between two persons (such as the customer and the staff person) can be carried out by monitoring the postures and gestures of the “skeletons” of the persons such as the methods disclosed in the following publications:
Z. Cao, G. Hidalgo, T. Simon, S.-E. Wei and Y. Sheikh, “OpenPose: Realtime Multi-Person 2D Pose Estimation Using Part Affinity Fields,” in IEEE Trans. on Pattern Analysis and Machine Intelligence, vol. 43, no. 1, pp. 172-186, 1 Jan. 2021
G. Ren, X. Lu and Y. Li, “A Cross-Camera Multi-Face Tracking System Based on Double Triplet Networks,” in IEEE Access, vol. 9, pp. 43759-43774, 2021;
Nanyang Wang, Yinda Zhang, Zhuwen Li, Yanwei Fu, Wei Liu, Yu-Gang Jiang; Pixel2Mesh: Generating 3D Mesh Models from Single RGB Images; Proc. of the European Conference on Computer Vision (ECCV), 2018, pp. 52-67;
US Patent Application Publication No. US2019/0332785 titled “REAL-TIME TRACKING AND ANALYZING TO IMPROVE BUSINESS, OPERATIONS, AND CUSTOMER EXPERIENCE”;
K. Hu, L. Yin, and T. Wang, “Temporal Interframe Pattern Analysis for Static and Dynamic Hand Gesture Recognition,” 2019 IEEE International Conference on Image Processing (ICIP), 2019, pp. 3422-3426; and
M. Asadi-Aghbolaghi et al., “A Survey on Deep Learning Based Approaches for Action and Gesture Recognition in Image Sequences,” 2017 12th IEEE International Conference on Automatic Face & Gesture Recognition (FG 2017), 2017, pp. 476-483.

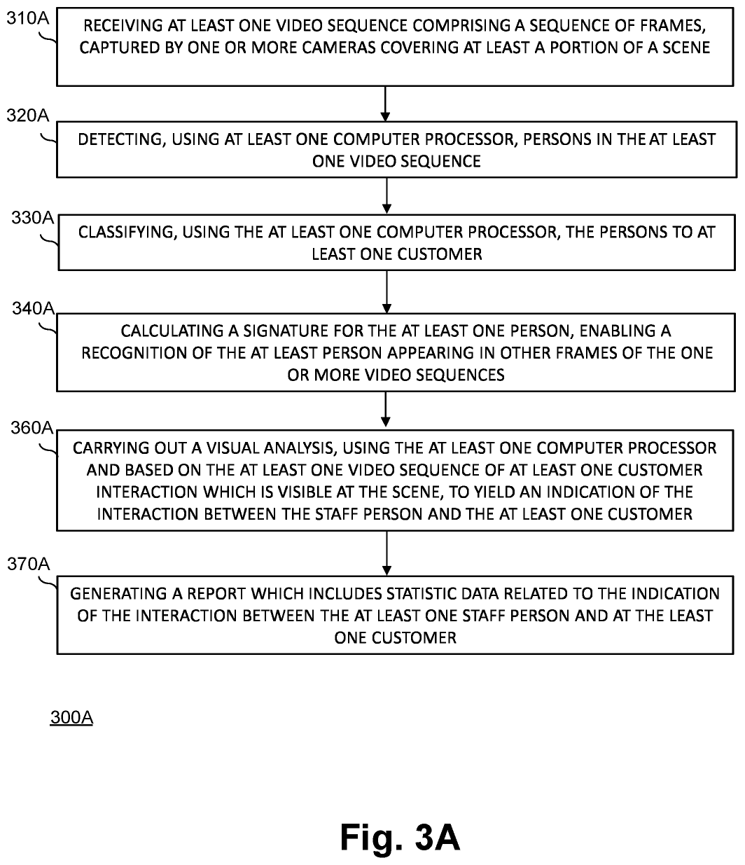

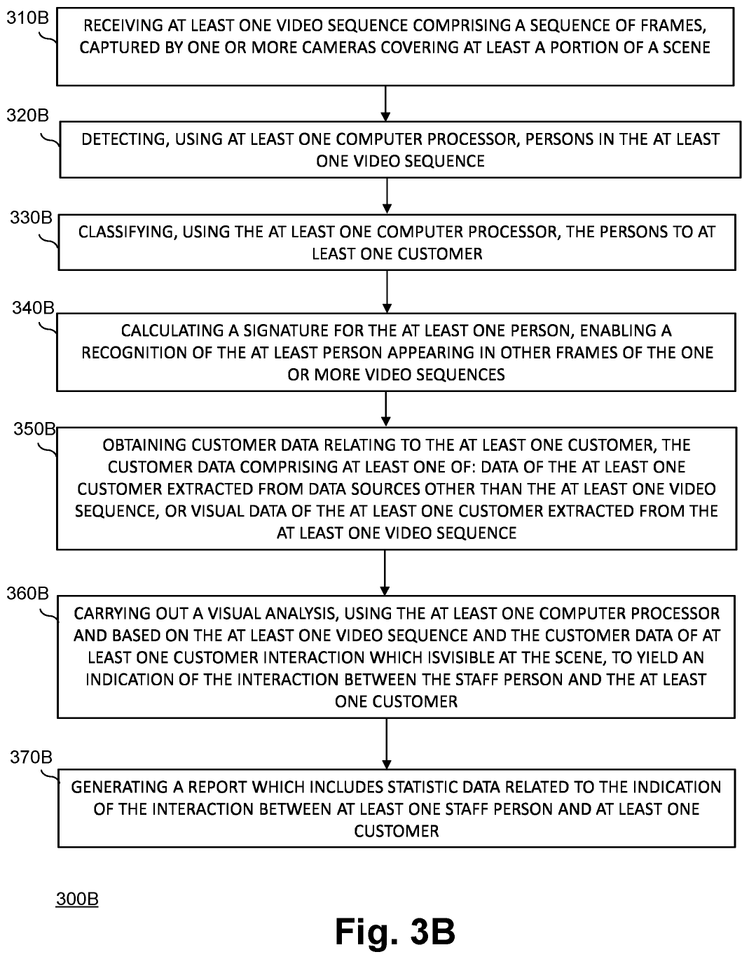

FIG. 3A is another high-level flowchart illustrating a method in accordance with some embodiments of the present invention. Method 300A for visual analysis of customer interaction at a scene, may include the following steps: receiving at least one video sequence comprising a sequence of frames, captured by one or more cameras covering at least a portion of the scene 310A; detecting, using at least one computer processor, persons in the at least one video sequence 320A; classifying, using the at least one computer processor, the persons to at least one customer 330A; calculating a signature for the at least one person, enabling a recognition of the at least person appearing in other frames of the one or more video sequences 340A; carrying out a visual analysis, using the at least one computer processor and based on the at least one video sequence of at least one customer interaction which is visible at the scene, to yield an indication of the interaction between the staff person and the at least one customer 350A; and generating a report which includes statistic data related to the indication of the interaction between the at least one staff person and at the least one customer 360A.

FIG. 3B is yet another high-level flowchart illustrating a method in accordance with some embodiments of the present invention. Method 300B for visual analysis of customer interaction at a scene, may include the following steps: receiving at least one video sequence comprising a sequence of frames, captured by one or more cameras covering at least a portion of the scene 310B; detecting, using at least one computer processor, persons in the at least one video sequence 320B; classifying, using the at least one computer processor, the persons to at least one customer 330B; calculating a signature for the at least one person, enabling a recognition of the at least person appearing in other frames of the one or more video sequences 340A; obtaining customer data relating to the at least one customer, the customer data comprising at least one of: data of the at least one customer extracted from data sources other than the at least one video sequence, or visual data of the at least one customer 350A; carrying out a visual analysis, using the at least one computer processor and based on the at least one video sequence and the customer data of at least one customer interaction which is visible at the scene, to yield an indication of the interaction between the staff person and the at least one customer 360A and generating a report which includes statistic data related to the indication of the interaction between at least one staff person and at least one customer 270B.

According to some embodiments of the present invention, reports generated based on system 100 and methods 200, 300A and 300B may be useful for several use cases. In many cases stores would like to know at checkout the staff persons who helped a customer. This can be done automatically from the video captured by the installed cameras. While most facilities may keep the statistics generated by customer interaction analysis confidential, in some cases such analysis results can be made public. An example is an Emergency Room, which can publish the average time from an arrival of a patient until approached by medical personnel. Such data can be used to direct new patients to the hospital having the shortest waiting time. Yet another example may be an average time a customer spends in waiting to be serviced in a supermarket or any other place that has queues.

According to some embodiments of the present invention, the reports generated may include statistical data related to one all or more of all customers on the database and further to one or more of all staff persons stored on the database. The reports may be usable for the management for several purposes: (i) determine efficiency of each staff person; (2) Provide information that will enable the optimization of the preferred numbers and locations of staff person to improve customer interaction and customer experience in general.

While the embodiments described above so far suggested the analysis of interaction with customers using video recorded by installed video cameras, system 100 can also be used in real time. For example, a waiting customer can be recognized in the video by noting a person that is dwelling longer than usual in an area, and a staff person can be directed to this customer, for example via an alert on user interface 180. If useful, the staff person can be given information, for example via user interface 18, collected on the customer by tracking them over time and keeping the data on a database. The data collected may include locations visited, aisles where the customer stopped more than others, and the like.

According to some embodiments of the present invention, it is possible that a customer be recognized from previous visits to the store such as scene 80 or to other stores that share customer information. Such a customer can be matched to another visit in a store by appearance similarity such as face recognition, gate analysis, radio technologies based on Wi-Fi/Bluetooth signature of customer's phones and the like. Alternatively, a customer's identification can be recognized in case this customer appears in a database that the store or business collect over time and generated over time by tracking the customers, possibly via point-of-sale transactions being monitored and saved on a database.

It should be noted that once an area is covered by video cameras, and the staff person is aware of the video cameras, communication of the staff person with the system can occur by predetermined gestures. For example, a salesperson raising a hand may indicate a need for another salesperson to arrive. Raising a first may indicate an alert for security, etc. Such predetermined gestures can be prepared in advance and distributed to staff persons. In parallel, the video analysis systems can be trained to recognize these predetermined gestures.

A possible interaction may simply include the approximate distance between staff and customer. A possible customer behavior may include fitting, buying, leaving with no purchase, and the like.

In addition, system 100 may also be configured to have the ability to recognize merchandize and report statistics of merchandize (Size does not exist or fit). Specifically, system 100 may also be configured to provide an indication of the interaction with staff or customer with identified merchandize.

Finally, the results of the visual analysis according to embodiments of the present invention can be combined with other modalities: data from cash registers, data from RFID readers, and the like, to provide data fusion from visual and non-visual data sources. Such data can be combined, for example, by associating to a cash register transaction the closest client to the cash register at the time of the transaction as seen by the camera. In general different sources can be used by associating the location provided by the other sources (e.g location of cash register, location of RFID device) to the location or a person as computed from the video cameras.

As indicated above, the video sequences such as 32A and 32B are provided to system 100 either by stationary cameras 30A, 30B, and/or by body mounted camera 40 which may be mounted on staff person 20. The reminder of the disclosure herein provides some embodiments of the present invention which enable effectively collecting and combining visual data from stationery and person-mounted cameras alike.

Static (surveillance) cameras cover many areas. In addition, many people, e.g., policemen or salespeople, are carrying wearable cameras. In most cases videos from those cameras are stored in archives, and in some cases wearable cameras are only used for face recognition, with the video potentially not recorded.

So far, systems for storing surveillance videos and information derived from them were rarely connected to systems using wearable cameras or information derived from them. It was therefore difficult to combine the information in both types of videos.

Some embodiments of the present invention enable system 100 the ability to generate links between wearable and static cameras, and in particular combine information derived from both sets of videos. Such a system can optionally connect to other databases such as a database of employees, a database of clients, or a database of guests in hotels or cruise ships. Such databases may have information on objects such as people, cars, etc., including identification data such as license plate number, face image or face signature r, etc. It should be noted that the information derived from wearable cameras and from static cameras can be stored in separate databases, in a single database, and even in one large database together with other external information such as employee database, client database, and the like.

Video from either static or wearable cameras is analyzed for metadata. Such metadata can include time and location of video, and information of objects visible in the video. Such information can include face signature s for people, that can be used for face matching, sentiment description, a signature to identify activity, and more. Such metadata can be stored on a database and can be used to extract relevant information from databases existing on the same person.

In accordance with some embodiments of the present invention, system 100 can further provide a response to the following queries: when a wearable camera detects a face of a person, a face signature can be computed, and the appearance of the same face in other wearable cameras or surveillance cameras can be detected. Alternatively, the identification of this person is determined from its face picture, and information about the identified person is delivered. For example, when a customer approaches a salesperson equipped with a face recognition camera, the salesperson can be informed about relevant information about this customer taken from a general database by his identity, or from previous visits of customers in the shop by comparing face signature s.

It should be noted that face recognition can be used in several modes. In one mode, face signature can be used to extract an identity of a person as stored in a database. In another mode, no database with people's identity is used. In this mode only the face signature is computed and stored and compared to face signature s computed on other faces in possible other cameras and times. In this mode the activities of the same person can be used without the access to a database with people's identity.

The salesperson or anyone else with the wearable cameras can be equipped with an interaction device, such as a telephone or a tablet, to provide the information on the visible person that can be accessed from the databases, including data derived from the surveillance cameras. As there is much more information on any person stored in databases or collected using surveillance cameras, the interaction device, or a server connected to this device, can use a summarization and suggestion process that will filter the relevant information given the task of the salesperson. Any user connecting to the system will provide his role, such as a waiter in a particular restaurant, a salesman in a particular shop, a policeman, etc. This user profile can be selected from some predefined profiles or be tailored specifically for each user. For example, if the salesperson is a waiter in a restaurant, the device may display whether the person is a new client or an existing one, whether the client visited the same restaurant or others in the chain, and if available—display client's name to enable personalized greeting, display personalized food or drink preferences, etc. When a client approaches a salesman in a store, the salesman can be provided with information available from the surveillance cameras about the items examined by the client on the displays, his analyzed sentiment for the products he examined, etc. If the system has access to a database with previous visits and purchases, the system may even suggest products that may be suitable for this client.

In case of a salesman in a clothing store, the system may be able to compute estimates of the dimensions of the client from calibrated surveillance cameras, measure other features like skin, eye, and hair color, and the salesperson will be given the possible sizes of clothes and styles of items that will best fit this client. This is true, of course, for any item that should fit the person's size, color, or shape, even if it is not clothing, such as jewelry.

A user of this system will be equipped with a wearable camera, as well as an interaction device such as a tablet. The camera and the tablet will have a communication channel between them, and either device may have wireless communications to a central system. The wearable camera can extract face features or perform face recognition on its own or transmit the video to the tablet and a face signature will be computed on the tablet. The tablet could be preconfigured to a particular task (e.g., a waiter at a given restaurant or a salesman at a given jewelry store), or can be configured by the user once he starts using the system. Once the user is approached by a client, per user requests the system will access the databases that include information from the static surveillance cameras and will present the user with the relevant information according to the system configuration. Such information can include times of visits to similar stores, items viewed at these stores, and whatever emotion that can be extracted from views available on the surveillance video. In a clothing store such information can include cloth sizes.

When a specific surveillance camera is selected, the system can provide a user with a list of wearable cameras that, for any given time, show the same locations and events as seen in the surveillance camera. This will enable users examining surveillance video, and watching interesting events, to find the video showing the same event from a wearable camera. One possibility to implement this function is by comparing the visible scenes and activities in the fields of view of the respective videos.

Additionally, a list of wearable cameras visible inside the surveillance video may be used. This will enable a user examining surveillance video, and seeing there a person wearing a camera, to see the scene from the point of view of the wearable cameras. One possibility to implement this function is by computing the field of view of the surveillance camera, computing the locations of the wearable cameras from scene landmarks or from a GPS, and determining whether wearable cameras are in the desired field of view.

Using the two aforementioned lists identities of people wearing these cameras may also be available, possibly with an initial database associating people with particular cameras. These people could be contacted by a control center requested to perform some activities when needed.

When a specific wearable camera is selected, the system can provide a user with: a list of surveillance cameras that, for any given time, show the same event as seen in the wearable camera; a list of surveillance cameras that, for any given time, shows the person carrying that wearable camera; and a list of other wearable cameras viewing the same activity, possibly from other directions.

In a site covered by both fixed surveillance cameras as well as wearable or other moving cameras, video from all cameras can be used to extract a more complete information of the scene and the objects in the scene. For example, when a person is seen in one camera and later in another camera, it is desirable to associate together all appearances of the same person. However, this can sometimes be difficult due, for example, to a different viewpoint in each camera (and even at different times in the same camera). In this case, when that person becomes visible in a wearable camera while moving between the surveillance cameras, the location, time and appearance as seen in the wearable camera or cameras can help in association a complete path of the desired person.

Another major challenge in a video surveillance system is tracking people between cameras. Major reasons for that are: Camera's fields of view are not necessarily overlapping. Thus, there are “dead zones”; Surveillance cameras are mainly installed to watch top down, thus can hardly see people's faces; Surveillance cameras try to cover large areas thus the resolution is limited to capture small unique details; Different cameras capture the same people in different poses, such that people's appearance looks different; Due to changes in illumination as well as different camera characteristics, colors might look different between cameras. This problem is normally referred to as “color constancy” issue; and even in the same camera, it's not always easy for algorithms to track people due to occlusions.

However, for a single surveillance camera, we have today relatively robust computer vision algorithms that can track people either by extracting features and tracking them, or by using similarity deep neural networks. As a result, each surveillance camera can generate “tracks” of people, without being able to relate those “tracks” to the same person in case he moved from one camera to another or even left the field of view of a camera and returned later.

According to some embodiments of the present invention, a method to solve this challenge is provided by combining “tracks” generated by each surveillance camera with two additional methods. The first enables to translate a location in the image domain (i.e. pixel coordinates) into location in the real world (i.e. World coordinates). The second is based on wearable cameras that are carried by staff and can recognize faces (such as OrCam cameras) or translate faces into feature vectors.

Transformation of object coordinates from Image domain into World domain (“Pix to Point”) can be done in different ways. As an example, by knowing camera location and orientation as well as internal parameters, or by calibrating each camera by defining known locations in the real world on Image coordinates (four locations on a plane will be enough).

The location at any time of the “Face readers” is known either by RF triangulation method (Bluetooth, Beacons etc.) or by computer vision algorithm that can detect and recognize within the camera field of view the staff person (based on typical uniforms) that carrying it. Once anonymous “tracks” and the list of detected faces or face feature vectors reside in the database, “tracks” fusion algorithm merges different “tracks” by attaching specific identity (according to detected faces time and location) to each “track”. This enables continuous tracking of people between cameras.

It should be noted that methods according to embodiments of the present invention may be stored as instructions in a computer readable medium to cause processors, such as central processing units (CPU) to perform the method. Optionally, some or all algorithms may run on the camera CPU. Modern cameras may include strong CPU and Graphical Processing Unit (GPU) that may perform some or all tasks locally.

Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the methods according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for visual analysis of customer interaction at a scene, the method comprising:
receiving at least one video sequence comprising a sequence of frames, captured by one or more cameras covering at least a portion of the scene, said scene includes at least one staff person and at least one customer;
detecting, using at least one computer processor, persons in the at least one video sequence;
classifying, using the at least one computer processor, the persons to at least one customer;
calculating a signature for the at least one person, enabling a recognition of said at least person appearing in other frames of the one or more video sequences; and
carrying out a visual analysis, using the at least one computer processor and based on the at least one video sequence of at least one customer interaction which is visible at the scene, to yield an indication of the interaction between said staff person and the at least one customer.

2. The method according to claim 1, further comprising obtaining customer data relating to the at least one customer, said customer data comprising at least one of: data of the at least one customer extracted from data sources other than the at least one video sequence, or data of the at least one customer extracted from the at least one video sequence, wherein the visual analysis is further based on said customer data.

3. The method according to claim 1, wherein at least one of the one or more cameras is mounted on the staff person.

4. The method according to claim 1, wherein at least one of the one or more cameras are cameras pre-installed in fixed locations.

5. The method according to claim 1, wherein said behavior of the at least one customer comprises movement pattern of the at least one customer at said scene.

6. The method according to claim 1, wherein said behavior of the at least one customer comprises an interaction of at least one customer with goods displayed for sale at said scene.

7. The method according to claim 1, wherein at least one visual analysis visible interaction between at least one staff person present at the scene and the at least one customer is derived from a sequence of at least one of postures and gestures of the staff person and the customer.

8. The method according to claim 7, wherein the at least one visible interaction between at least one staff person present at the scene and the at least one customer, are captured by at least one camera mounted on the staff person.

9. The method according to claim 1, wherein the interaction between said staff person and the at least one customer corresponds with no interaction.

10. The method according to claim 1, wherein the behavior of the customer is derived based on visual analysis carried out based on the recognition of said at least one customer in said one or more video sequence.

11. The method according to claim 1, further comprising classifying, using the at least one computer processor, the persons to at least one staff person.

12. The method according to claim 11, wherein the at least one visible interaction between at least one staff person present at the scene and the at least one customer, is based on at least one video sequence in which both the staff person and the customer appear.

13. The method according to claim 1, further comprising generating a report, based on the indication of the interaction between said staff person and the at least one customer, and providing said report in a format usable for assessing performance of the at least one staff person.

14. The method according to claim 1, further comprising generating a report, based on the indication of the interaction between said staff person and the at least one customer, and providing said report in a format usable for the at least one staff person to improve the interaction with the customer.

15. A system for visual analysis of customer interaction at a scene, the system comprising:
a plurality of cameras configured to capture at least one video sequence comprising a sequence of frames, covering at least a portion of the scene, said scene includes at least one staff person and at least one customer; and
a computer processor configured to:
detect, using at least one computer processor, persons in the at least one video sequence;
classify using the at least one computer processor, the persons to at least one customer;
calculate a signature for the at least one person, enabling a recognition of said at least person appearing in other frames of the one or more video sequences; and
carry out a visual analysis, using the at least one computer processor and based on the at least one video sequence of at least one customer interaction which is visible at the scene, to yield an indication of the interaction between said staff person and the at least one customer.

16. The system according to claim 15, wherein the computer processor is configured to: obtain customer data relating to the at least one customer, said customer data comprising at least one of: data of the at least one customer extracted from data sources other than the at least one video sequence, or data of the at least one customer extracted from the at least one video sequence, wherein the visual analysis is further based on said customer data.

17. The system according to claim 15, wherein at least one of the one or more cameras is mounted on the staff person.

18. The system according to claim 15, wherein at least one of the one or more cameras are cameras pre-installed in fixed locations.

19. The system according to claim 15, wherein said behavior of the at least one customer comprises movement pattern of the at least one customer at said scene.

20. A non-transitory computer readable medium for visual analysis of customer interaction at a scene, the computer readable medium comprising a set of instructions that when executed cause at least one computer processor to:
instruct a plurality of cameras configured to capture at least one video sequence comprising a sequence of frames, covering at least a portion of the scene, said scene includes at least one staff person and at least one customer;
detect, using at least one computer processor, persons in the at least one video sequence;
classify using the at least one computer processor, the persons to at least one customer;
calculate a signature for the at least one person, enabling a recognition of said at least person appearing in other frames of the one or more video sequences; and
carry out a visual analysis, using the at least one computer processor and based on the at least one video sequence of at least one customer interaction which is visible at the scene, to yield an indication of the interaction between said staff person and the at least one customer.
